(19) United States
(12) Patent Application Publication
(10) Pub. No.: US 2025/0094702 A1
(43) Pub. Date: Mar. 20, 2025

(54) SYSTEM AND METHOD FOR COMPARING VERSIONS OF HTML DOCUMENTS IN A PROOFING INTERFACE

(71) Applicant: Justin Khoo, San Francisco, CA (US)

(72) Inventor: Justin Khoo, San Francisco, CA (US)

(21) Appl. No.: 18/965,681

(22) Filed: Dec. 2, 2024

Related U.S. Application Data
(63) Continuation-in-part of application No. 17/663,196, filed on May 12, 2022, now Pat. No. 12,159,103.
(60) Provisional application No. 63/187,886, filed on May 12, 2021.

(51) Int. Cl. G06F 40/197; G06F 3/0481

(52) U.S. Cl. CPC G06F 40/197; G06F 3/0481

(57) ABSTRACT

Embodiments of a system and method for comparing multiple versions of HTML documents in a proofing interface. The system allows users to compare different versions of a document, highlighting changes in textual and graphical content, and managing comments and annotations across revisions. Users can toggle between different display modes, such as mobile and desktop views, and initiate comparisons between document versions through an interactive control interface. The system is particularly suited for collaborative environments where document revisions are frequent, and accurate tracking of changes is essential. Embodiments of an interface allowing annotations such as pins or comments to be placed persistently in a document, whether a document is displayed with or without highlights that might otherwise cause the annotation to change position. Embodiments of the present invention generally relate to the comparison of multiple HTML documents in a user interface. The HTML documents may comprise web pages, emails, or other forms of documents. A user interface presents differences between the documents in a way that is visible to the user.

### CROSS-REFERENCE TO RELATED APPLICATIONS

This application is a continuation-in-part of and claims priority from U.S. patent application Ser. No. 17/663,196, filed May 12, 2022, of Khoo, which claims priority from U.S. Provisional filing Ser. No. 63/187,886, of Khoo, filed May 12, 2021, both of which are hereby incorporated by reference herein in their entirety, including Appendices A and B of the provisional application.

### FIELD

Embodiments of the invention relate to systems and methods for comparing multiple versions of HTML-based documents in a proofing interface. More particularly, it involves managing revisions, displaying differences between document versions, and handling comments and annotations across said versions within the interface.

### BACKGROUND

In collaborative environments, users frequently review and proof multiple versions of documents, such as web pages or emails that include HTML content. Over time, different versions are created, and there is often a need to compare these versions to track changes, review updates, and manage annotations and comments made on prior iterations. Current tools for comparing HTML documents often fall short in their ability to manage multi-version comparisons, as well as to associate comments with specific document versions. Existing systems either focus solely on single HTML document comparisons or offer only basic side-by-side version displays without robust features for handling multiple revisions and annotations.

A more comprehensive solution is required, one that facilitates detailed comparisons between document versions and provides a system for managing and navigating comments and annotations associated with specific revisions.

There is often a need to review and compare multiple documents by users for purposes such as comparing different versions of documents to each other, or variations of a document. One example of comparing variations of a document is in email campaigns where a single email campaign may comprise variations of a single email where parts of the emails are changed or personalized based on the recipient's demographic or segment in a database. For example, variations of emails may show a user different offers based on the user's past purchases.

The variations may also include information such as a recipient's name, loyalty tier or location. This may also include extra pieces of content such as a personalized coupon code or information about past purchases

Conventionally, there are a few approaches to comparing documents such as web pages but they come with certain limitations.

An example of a one conventional way to compare two web pages is by capturing an image or screenshots of two web pages and overlaying the screenshots of the two web pages over each other and showing the differing content using tools such as ImageMagick and BBC's Wraith. The downside of this is that slight differences in placement of content will result in the misalignment of content, causing even similar content to be highlighted as if the content itself had changed. This method also makes identifying differences in textual content difficult since overlaying different text over each other results in a garbled and undecipherable image.

An example of more promising and practical prior art for comparing documents is using HTML diffing tools like the W3C Html Diff Website (https://services.w3.org/htmldiff) (“W3C HTML Diff”) or the htmldiff javascript library https://github.com/tnwinc/htmldiff.js (“htmldiff library”) which does an HTML compare between two documents and highlighting the text changes. This method benefits from being able to highlight textual changes as well as not be susceptible to minor changes in placement of textual content. Other prior art HTML diffing solutions can be viewed here: https://www.w3.org/wiki/HtmlDiff.

However conventional HTML diffing tools suffer from several shortcomings. Firstly, since they are primarily textual in nature these tools fail to highlight the changes to areas that are not textual, such as the changes of a structure of a web page, for example, if a button is present in one page and not another, instead of showing that the button has been added, the current diffing tools highlight the text within the button which can confuse users leading them to try to locate the button in the other page which isn't there.

Conventional HTML diffing tools also suffer from the inability to detect the difference of visible elements when rendered since these tools only analyze the actual HTML markup and not the rendered state of the elements. Therefore, if both documents contain an element (i.e. a button) but one document has the button displayed and the other has the button hidden through Cascading Style Sheets (CSS) (i.e. display: none), the HTML diffing tool would detect no difference since the difference in visibility only takes effect during rendering.

Lastly HTML diffing tools often compare text across container boundaries. Which means text within several consecutive containing elements (such as divs or tables) might be compared as a whole making the tool highlight differences in text across unrelated sections.

Refer to FIG. 17 which features an example of a prior art website at https://services.w3.org/htmldiff “W3C HTML Diff” that allows for the input of two URLs which will be compared and the difference shown.

FIG. 18 shows the result comparison of two HTML documents using the service shown in FIG. 17. The first document 18001 with two div containers with text with a first image 18004, the second document 18002 with 3 containers with text and a second image 18005 in the proximate location of the first image and the result of the comparison by the W3C HTML Diff in 18003 wherein the second image is displayed 18006.

The conventional methods suffer from the following drawbacks.
1) The comparison ignores container boundaries so even though there are differing text within all the containers, only one container (the third one) is highlighted by the prior art to have “differing” text. Although textually this may be “correct”, visually based on the boundaries of the containers this is erroneous as it does not show the textual differences within each container.
2) The comparison does not show that the second document 18002 contains an extra container. Therefore, users viewing the comparison result would not be notified that the number of containers has changed-either added or removed.
3) The container with changes is not highlighted, so users cannot at a glance appreciate any non-textual changes between them.
4) Having just one view 18003 of both the additions and deletions can be confusing as seen in 18003. It would be advantageous to have both documents visible and highlighting the differences in the respective documents.

### SUMMARY

Many web sites and emails are built using modules within content management systems where these modules placed into a canvas to build a complete document.

Often it can be useful to view changes as “blocks” of content instead of merely highlighting textual or imagery differences.

It is a goal of embodiments of the present invention to overcome the current deficiencies of the prior art as well as to support the review of differences between multiple HTML documents such as web pages and emails as “blocks” or “rows” instead of just text highlights.

Accordingly, embodiments of the present invention are directed to providing a system and method that will allow the comparison of multiple documents containing HTML to each other-allowing the user to quickly see the differences not only in textual content but also the structure of the documents. These documents may include but are not limited to web pages and email messages.

Embodiments of the invention disclosed herein provide a system and method for comparing multiple versions of a document containing HTML content within a proofing interface. The system allows users to view different document versions side-by-side, highlighting changes in textual and graphical content between versions. It also manages comments and annotations tied to specific document revisions, thereby enabling reviewers to easily track modifications and compare current content against earlier iterations.

In an embodiment, the system includes a preview interface wherein users can view various document versions. The interface allows for toggling between different viewing modes, such as desktop and mobile views. Additionally, annotations and comments are displayed in the interface, and the user can interact with these elements to trigger comparisons between the relevant document versions. The system can also highlight specific changes in content, such as added or removed text, as well as differences in graphical elements like images.

Embodiments of the present invention also allow for the identification of areas that are missing from one document to another as well as easily highlight areas of content using visual indicators such as borders or outlines around content or other visual indicators.

Embodiments of the present invention also allow for comparison of the same document in multiple container dimensions—and hence allow the user to easily identify areas that may have changed (i.e., the display of buttons or hiding of images) from one view to another when for example the width of the document changes.

An embodiment of the present invention covers the ability to detect and highlight elements containing images that have been modified between multiple documents.

### BRIEF DESCRIPTION OF THE DRAWINGS

FIG. 1 illustrates a schematic overview of a computing device, in accordance with an embodiment of the present invention.

FIG. 2 illustrates a network schematic of a system, in accordance with an embodiment of the present invention.

FIG. 3 is an illustration of an example embodiment of a user interface of an embodiment of the present invention used to compare two documents containing HTML.

FIG. 4 is an illustration of example embodiments of two documents containing HTML with similar structure containing differences in textual content.

FIG. 5 is an illustration of example embodiments of two documents containing HTML with differences in structure and textual content.

FIG. 6 is an illustration of example embodiments of two documents containing HTML with differences in structure and textual content with container elements outlined.

FIG. 7 is an illustration of example embodiments of two documents containing HTML with differences in structure and textual content rendered in a user interface displaying highlights denoting changes in content.

FIG. 8 is an illustration of an example process flow, in accordance with an embodiment of the present invention-depicting the process of identifying, matching and highlighting changes in content between two documents containing HTML.

FIG. 9 is a table of an example comparison of content within a chunk of one document compared with the content of a list of chunks in a separate document.

FIG. 10 are two tables of example matching of chunks within one document with chunks in a separate document.

FIG. 11 is an illustration of an example process flow, in accordance with an embodiment of the present invention-depicting the process of identifying and highlighting changes of image content and text between sections of two documents containing HTML.

FIG. 12 is an illustration of example embodiments of sections of two documents containing HTML with differences in textual and image content.

FIG. 13 is an illustration of example embodiments of sections of two documents containing HTML with differences in textual and image content (of FIG. 12) rendered in a user interface displaying highlights denoting changes in content and images.

FIG. 14 is an illustration of example embodiments of the HTML markup of sections of two documents containing HTML with differences in textual and image content.

FIG. 15 is an illustration of example embodiments of the HTML markup of sections of two documents containing HTML with differences in textual and image content (of FIG. 14) after hidden text metadata for images has been generated.

FIG. 16 is an illustration of example embodiments of the HTML markup of sections of two documents containing HTML with differences in textual and image content (of FIG. 14) after hidden text metadata for images has been generated (FIG. 15) and markup has been added to visually highlight textual changes.

FIG. 17 is an example of a prior art website that compares two HTML documents and displays the difference.

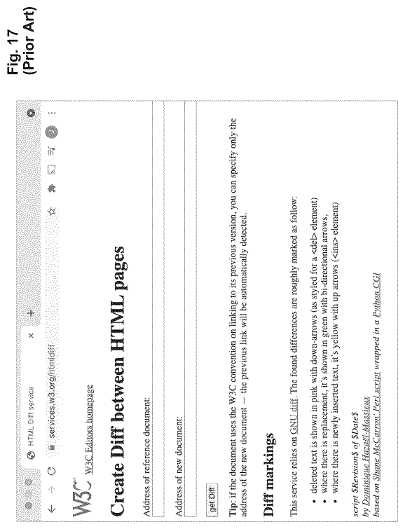

FIG. 18 is an example of a prior art website showing the result of the comparison of two HTML documents.

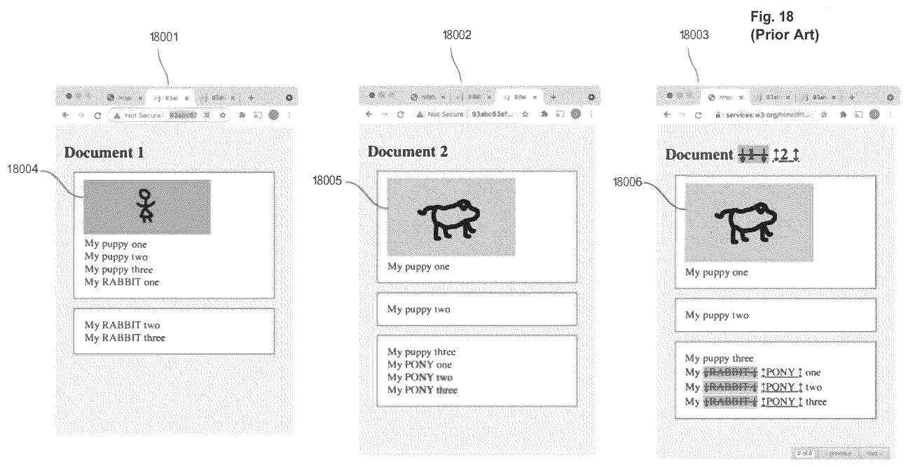

FIG. 19 illustrates a proofing interface showing a version of a document with its associated comments and annotations.

FIG. 20 illustrates a comparison UI for displaying differences between two versions of a document.

FIG. 21 illustrates a context layer displaying controls related to a specific annotation or pin of a comment.

FIG. 22 illustrates a process flow for rendering comments in a comment stream and generation of comparison links.

FIG. 23 illustrates a process flow for triggering and executing a comparison between document versions.

FIG. 24 displays a proofing interface with highlights enabled, including a pin placed on a highlighted element.

FIG. 25 shows the proofing interface with highlights disabled, illustrating the persistence of the pin relative to the underlying content.

FIGS. 26A and 26B show the HTML source of a document before and after highlight elements are added.

FIG. 27 demonstrates examples of XPath references with and without inclusion of highlight elements.

FIG. 28 is a flowchart illustrating the process of recording pin placement and calculating coordinates.

FIG. 29 is an alternate embodiment employing pointer-event disabling to facilitate pin placement.

### DETAILED SPECIFICATION

Embodiments of the present invention generally relates to the ability to display differences in content between multiple documents containing HTML-allowing the user to quickly see the differences not only in textual content but also changes in image content and structure of the documents. These documents may include but are not limited to web pages and email messages.

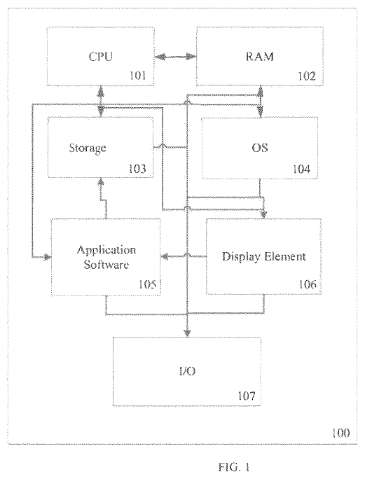

According to an embodiment of the present invention, the system and method is accomplished through the use of one or more computing devices. As shown in FIG. 1, one of ordinary skill in the art would appreciate that a computing device 100 appropriate for use with embodiments of the present application may generally comprise one or more of a Central Processing Unit (CPU) 101, Random Access Memory (RAM) 102, a storage medium (e.g., hard disk drive, solid state drive, flash memory, cloud storage) 103, an operating system (OS) 104, one or more application software 105, one or more display elements 106 and one or more input/output devices/means 107. Examples of computing devices usable with embodiments of the present invention include, but are not limited to, personal computers, smartphones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an example embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be performed by a user of a computing device whether connected to a network or not. Some of the embodiments of the present invention may not be accessible when not connected to a network, however a user may be able to compose data offline that will be consumed by the system when the user is later connected to a network. Generally, instructions performing the methods discussed herein are stored in a memory, such as RAM 102 and performed by a processor, such as CPU 101.

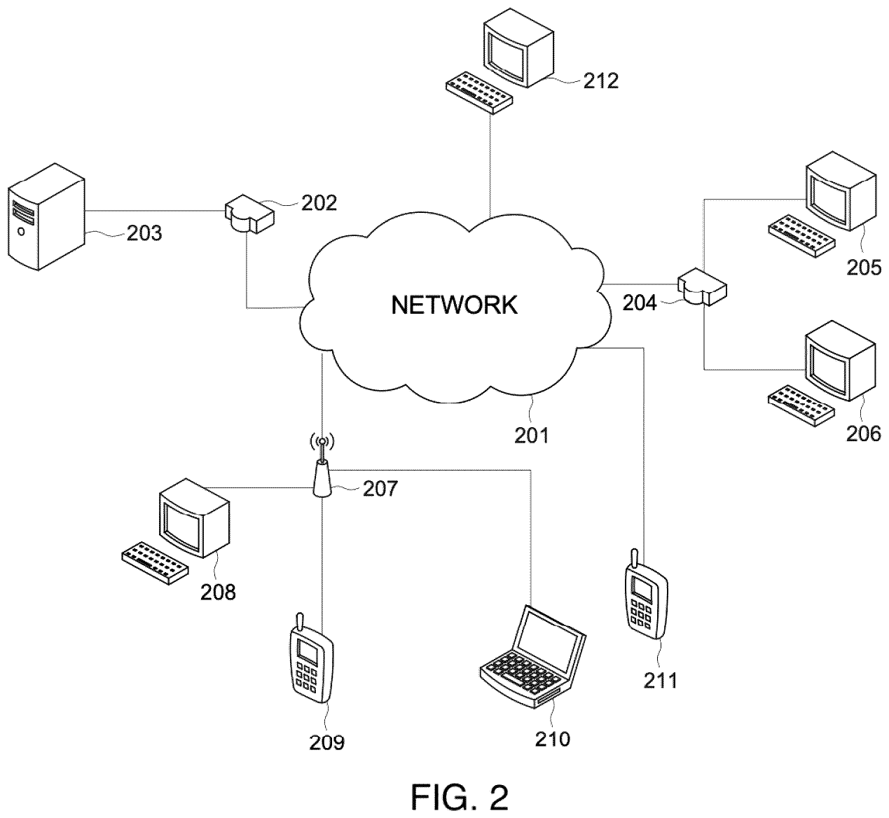

Referring to FIG. 2, a schematic overview of a system in accordance with an embodiment of the present invention is shown. The system comprises one or more application servers 203 for electronically storing information used by the system. Applications in the application server 203 may retrieve and manipulate information in storage devices and exchange information through a Network 201 (e.g., a WAN, the Internet, a LAN, WiFi, Bluetooth, etc.). Applications in server 203 may also be used to manipulate information stored remotely and process and analyze data stored remotely across Network 201 (e.g., a WAN, the Internet, a LAN, WiFi, Bluetooth, etc.).

According to an example embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with embodiments of the present invention may or may not utilize one or more routers 202. One of ordinary skill in the art would appreciate that there are numerous ways server 203 may connect to Network 201 for the exchange of information, and embodiments of the present invention are contemplated for use with any method for connecting to networks for the purpose of exchanging information. Furthermore, while this application refers to high speed connections, embodiments of the present invention may be utilized with connections of any speed.

Components of the system may connect to server 203 via Network 201 or other network in numerous ways. For instance, a component may connect to the system i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, server 203 could comprise a personal computing device, such as a smartphone, acting as a host for other computing devices to connect to.

### Chunks

As used herein, the term “chunk” relates to any rectangular shaped container of HTML content such as block elements-including but not limited to divs, tables, table cells—that meet a “chunk criteria”. The term “block elements” will be used to denote any rectangular shaped element although it can be appreciated that any element rectangular in shape may be used certain embodiments.

In various embodiments, the chunk criteria may include one or more of: a minimum height and/or width of an element in some units such as pixels, whether the element is currently displayed (vs hidden-such as using the CSS display: none), the exclusion of certain elements in a predefined list of elements (for example table rows), and whether or not a container is inside of a “leaf chunk”. In an embodiment, a chunk criteria is stored in, for example, storage 103 or RAM 102 of FIG. 1.

As used herein, the term “leaf chunk” relates to when a chunk (a container meeting the chunk criteria) contains one or more “terminal nodes”. In various embodiments of the invention, a terminal node may comprise an image or a text node (i.e. plain text content) or inline or non strictly rectangular elements (such as span). Depending on the embodiment, certain terminal nodes may be disregarded or ignored as well—for example if the terminal node is near the top, the Document Object Model (DOM) tree or if a terminal node contains no content (i.e. empty text node) or is deemed insignificant-such as a tiny image or element. A disregarded terminal node means that the node is not taken into consideration when determining if its parent is a “leaf chunk”.

A chunk of one document that has no matching chunk on another compared document is referred to as an “orphan chunk”. In an embodiment of the invention, an orphan chunk is also a leaf chunk.

### User Interface

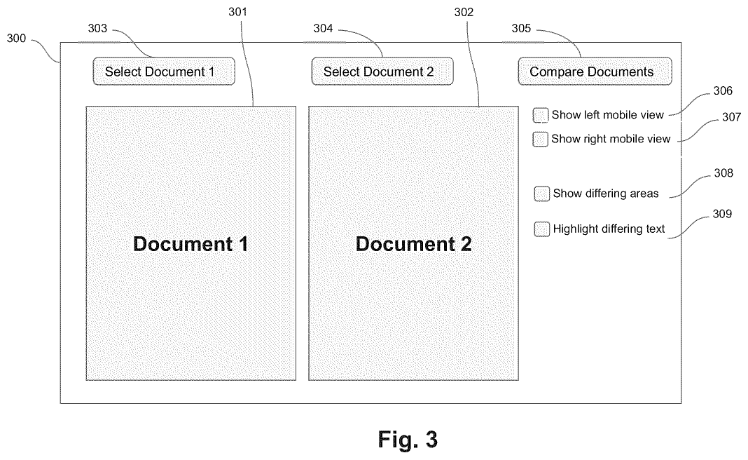

FIG. 3 depicts a user interface 300 of an embodiment of the present invention wherein two documents 301 and 302 containing variation in HTML content are being displayed in the user interface. The user interface provides a user a means to select or input documents containing HTML 303 and 304 (for example, buttons 303 and 302 might be a dropdown list) and a button 305 to execute the comparison process that will visually highlight the differing content between the two documents within the user interface. It will be understood that the contents of Document 1 and Document 2 are displayed in user interface 300.

Furthermore, an embodiment of the user interface contains options that allow the user to select a mobile view 306, 307 which allow adjusts the width of the containers from a “desktop view” (i.e. 800 pixels wide) to a “mobile view” (i.e., 400 pixels wide) of the documents as well as options whether to display markings such as an outline (border) around differing areas (chunks) 308 of content and highlighting of differing text 309 within matching chunks.

### Structure of Documents

### Discussion of Conventional Systems: Similar DOM Structure Comparison

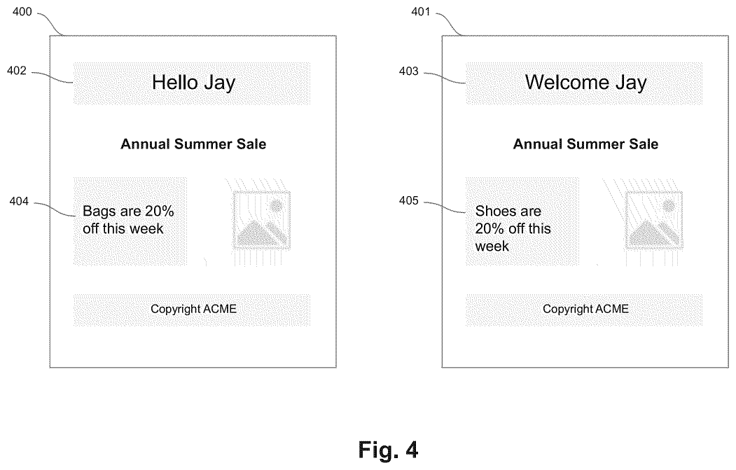

FIG. 4 depicts two documents 400/401 with a similar structure (DOM element structure) but with minor differences in textual content 402, 403, 404, 405. The documents 400 and 401 are good candidates for conventional methods to compare changes in content because they are somewhat similar in content (text and images) and in structure. For the image comparison conventional approach, overlaying an image rendering of 400 over 401 would clearly show two areas of differing content and HTML Diff method would be able to easily highlight the simple textual content differences between the two documents.

### Discussion of Conventional Systems: Different DOM Structure Comparison

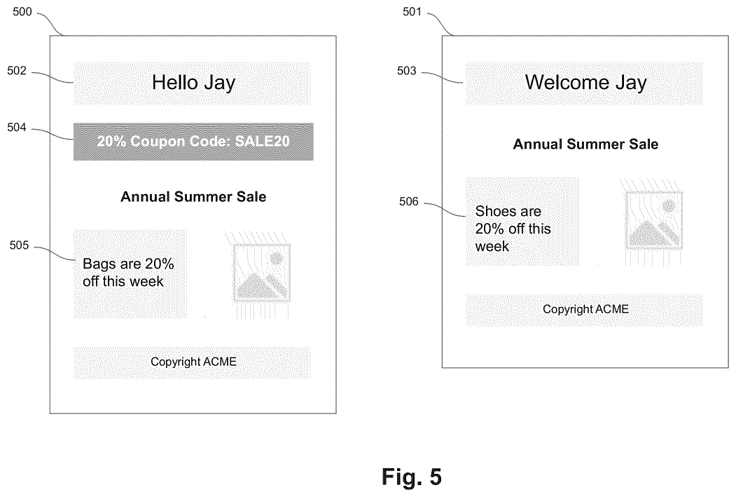

FIG. 5 depicts two documents 500/501 with a difference in structure (DOM element structure)—an inclusion of an element containing content 504—as well as difference in textual content 502, 503, 504, 506.

The documents 500 and 501 are examples where conventional methods are deficient in being able to compare changes in content because the two documents have multiple differences in both content and structure

For the conventional image comparison approach, overlaying an image rendering of 500 over 501 would show large differences in content below the first content area 502, 503 even though in actuality most of the content are similar. This is due to the inability of image-based comparisons to account for changes of the positioning of content within two documents. Here, “Annual Summer Sale” is present in both documents, but is located in a different location.

For the conventional HTML comparison approach (HTML diff), the approach would result in the difference in text in 502, 503, 505, 506 being highlighted as well as the entire text in 504 being highlighted. Unfortunately, having 504 highlighted does not convey to a user that the complete section is unique to 500. A user may assume that the section exists in 501, but just with a different text. Therefore, a different approach is suggested by embodiments of the present invention.

### Explanation of Embodiments of the Present Invention

### Breaking a Document Into Chunks

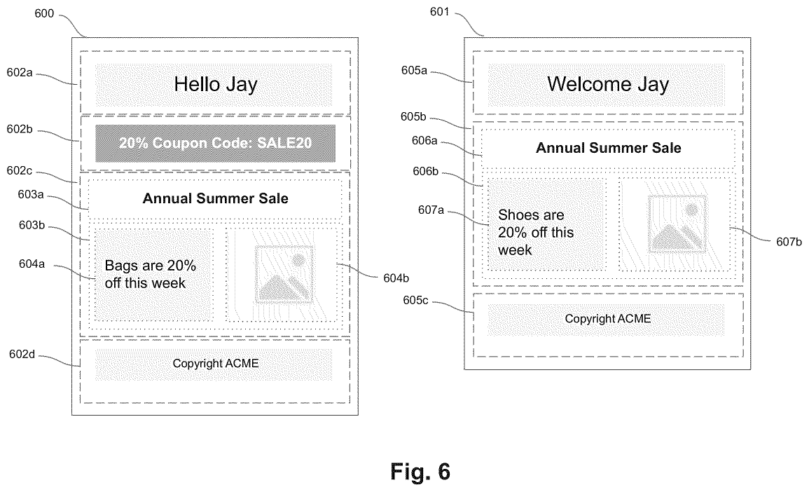

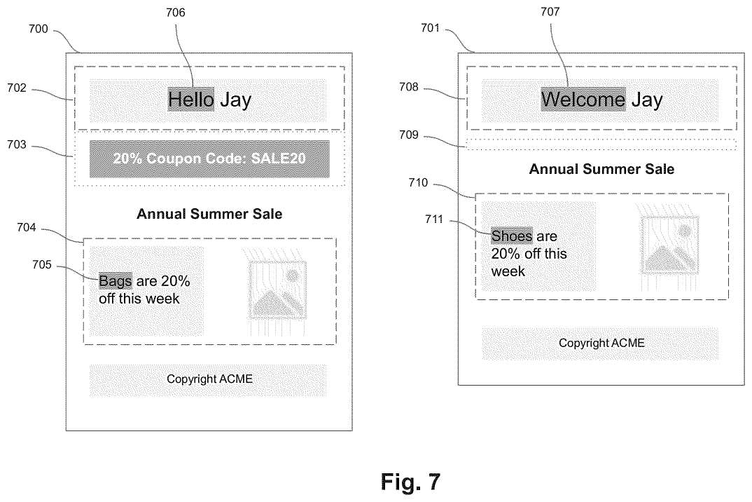

According to an embodiment of the present invention, a method to compare two documents breaks the documents into chunks. FIG. 6. Is an illustration of two documents where dashed outlines denote block elements (rectangle containers) 602a, 602b, 602c, 602d, 605a, 605b, 605c that are a direct or immediate children of the respective top level containers within the documents 600, 601, some of which contain differences in structure as well as textual content. Some of the first level block elements contain child block elements denoted with dotted outlines 603a, 603b, 604a, 604b, 606a, 606b, 607a, 607b. The dashed and dotted outlines illustrated in FIG. 7 in particular are visible outlines that are visible to a user to help a user identify chunks where content has been added or changed (unlike outlines in FIG. 6, which are provided to aid in understanding of the embodiment as they merely serve to illustrate the boundaries of various block elements).

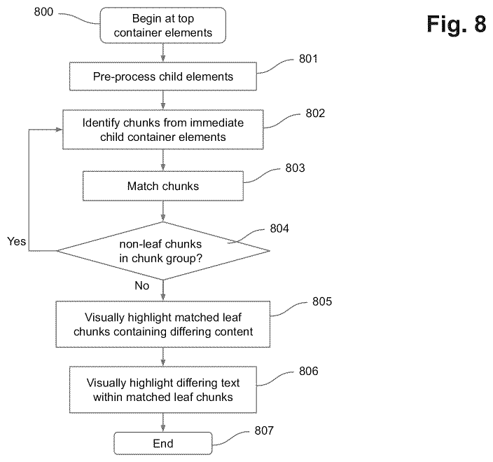

FIG. 8 is a flow chart of an embodiment of the presentation invention which denotes the process flow to highlight differing chunks and text between two documents. We will illustrate the flow by showing what happens in an example of two documents shown in FIG. 6 with the resulting outlines and highlights being displayed in FIG. 7.

The process begins when the documents in FIG. 6 have been loaded and into the user interface 300 and rendered (or displayed) where in the first document 600 is loaded into the first area 301 and the second document 601 is loaded into the second area 302 and the user clicks on the Compare Document button 305. The user has also selected to show differing areas 308 and highlight different text 309.

At 800, the process obtains references to the “top level element” in the first 600 and second 601 documents. The first document may also be referred to as the “left document” and the second document may also be referred to as the “right document”.

The top level element in this embodiment is the <body> tag, however, it can be appreciated that any element within a document can be used as the “top level element” for example when there are static heads and footers and the goal is to only compare a particular section within both documents wherein that section can be used as the “top level” element. Methods to obtain a reference to elements in a rendered HTML document using the Document Object Model (DOM) are well known to those skilled in the art.

In an embodiment of the invention, the user interface is a web page implemented in Javascript and both documents 600 and 601 are loaded within iframes in the areas 301 and 302. The purpose of embedding documents in iframes is to prevent any CSS styles of the documents affecting the styles of the user interface. However, it can be appreciated that the user interface may be a “native” application implemented in languages such as Objective C, VisualBasic or other languages and iframes may not be required in all embodiments.

Element 801 is an optional element wherein certain elements are modified to enhance the process of matching and comparing chunks and will be explained in the section Optional Matching Optimizations.

At Element 802, direct or immediate child nodes of the referenced elements of both documents are located and categorized into one of three types: i) terminal nodes, ii) eligible nodes and iii) discarded nodes. Terminal nodes in an embodiment of the invention may comprise text nodes, inline elements and images. Eligible nodes may comprise block elements.

Depending on the configuration and progress of the process of identifying chunks of content discarded nodes may comprise empty text nodes, empty elements, block elements smaller than a certain dimension in our case-less than 10 pixels wide (these elements are most probably spacers and don't contain meaningful data), hidden elements (such as elements set to display: none) and intrinsically invisible elements such as style and script tags. Empty elements as described may contain whitespace but no visible elements within.

In an embodiment of the invention, the calculation of dimensions of the elements are performed after the elements in the documents have been rendered in a user interface-such as in an iframe in a web browser. This means for example certain elements may not have their widths or heights set directly to the element and their widths and heights are dependent on the contents within it or containers wrapping it (i.e. width: auto). This is called the element's “layout width” or “layout height”—the dimensions the element occupies in the page. Calculating the layout widths of an element can be achieved using JavaScript and obtaining the element's “offsetWidth” and “offsetHeight” for layout height. Other methods to calculate an element's layout dimensions familiar to those who are skilled in the art can be used as well.

If a node can be categorized into multiple node types, the discarded node type takes precedence. Discarded nodes once categorized are ignored in the process flow. The reason for discarded nodes is that these elements are deemed insignificant and may pollute the process to determine ideal chunks in the document. For example, emails commonly attach a 1 pixel wide image that is used to track if the emails are opened. These pixels may be added at any part of the email and for the purposes of visual comparison has no significance. Similarly, image “spacers” only serve to help the layout of an email but have no significance otherwise so they can be ignored.

If there are no terminal nodes identified, then the eligible nodes are inspected to see if they pass a “chunk criteria” to be labelled as a chunk. In tan embodiment of the invention, the chunk criteria includes having a minimum height of 20 pixels and width of at least half the width of the content within the document (excluding the empty gutter/margin space to the left and right of the content). These values can depend on various preset configuration and a fixed width value may be used such as 400 pixels for document containers 800 px wide and 200 px for document containers 400 px wide. The reason for the minimum widths and heights is so that the highlight of a chunk area is meaningful—as the goal is to highlight “content modules” in the document-areas where the content creator has inserted chunks of content—and having too small an area to highlight may cause the document to highlight many small areas of differing content vs highlighting a wide container of differing content. Highlighting a large area instead of many small areas aids in the understanding of the user are the user will see the big picture instead of many small changes.

Using FIG. 6 as a reference, block elements 602a, 602b, 602c and 602d of the first document 600 and block elements 605a, 605b and 605c of the second document 601 are selected as first level (high level) “chunks” during the identification of chunks from the direct child elements of the top level elements. Chunks from a common parent are referred to as a “chunk group”.

### Comparing Chunks

At element 803 of FIG. 8 the first level (high level) chunk group of the first document 600 are compared to the first level chunk group of the second document 601. In an embodiment of the invention, string content within first level chunks of the first document are compared individually to the string content within the first level chunks of the second document-determining the best match among the chunks, determining if a chunk is a leaf and determining if a chunk has no matches.

The algorithm for the matches in an example embodiment uses the “element.innerText” JavaScript attribute to obtain the text strings of each chunk for comparison.

Comparison of strings to determine a score is well known to those skilled in the art. For example the string comparison function “string-similarity” javascript library (https://www.npmjs.com/package/string-similarity) which uses the Dice's Coefficient to compute a score between 0 and 1 between two strings, 0 meaning no similarity and 1 meaning exact match and various levels of similarity between 0 and 1. One skilled in the art may leverage other libraries and algorithms to determine a string similarity score-such as using, for example, the “Levenshtein distance” and “Hamming distance”. Other methods to compare content within chunks may be used to derive a score-such as using “element.innerHTML” which converts the markup within a chunk to string and comparing the markup and text together. Various alternatives may be used to improve the matching process such as ignoring whitespaces or removing certain attributes from elements before comparing.

A best match is deemed when a chunk from the first document has the highest score with a chunk of the second document compared to all the chunks in the chunk group of the second document and the chunk of the second document similarly has the highest score with the aforementioned chunk from the first document compared to all the chunks in the chunk group of the first document.

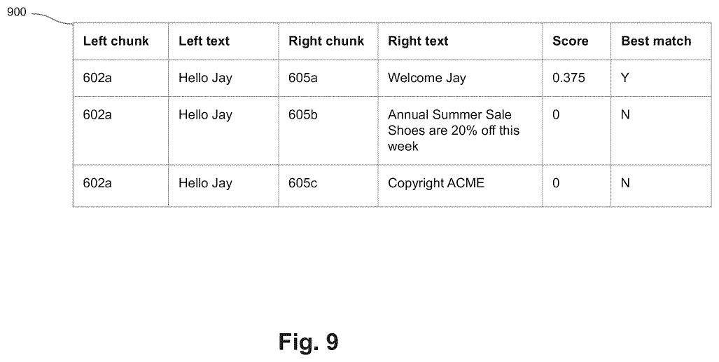

FIG. 9 900 is a table of an example comparison using the text contained within a 1st level chunk 602a on the first document with all the chunks 605a, 605b, 605c on the second document 601 with “left” referring to the first document and “right” referring to the second document. The score column shows the result of the comparisons with the best match between 602a and 605a.

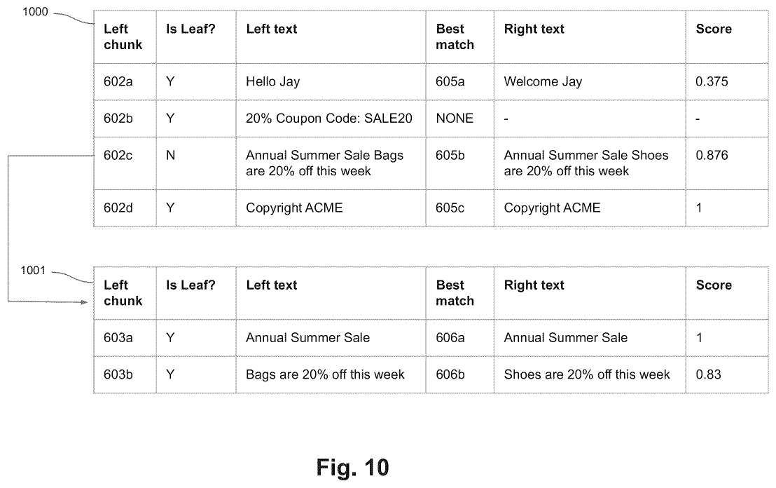

FIG. 10 1000 is a table of an example match between chunks of the chunk groups of the first document 600 and second document 601, wherein left denotes the first document and right denotes the second document. This table represents an example of output from one or more executions of element 803 of FIG. 8.

As can be seen in 1000, in the example match, there are four chunks in the first level chunk group in the first document but three chunks in the first level chunk group in the second document wherein the matching algorithm matched the chunks leaving the chunk with the lowest aggregate match score 602b without a corresponding match (it has the lowest score (zero) in its own chunk group when matched with every chunks in the second document). In this example, 602b is regarded as an “orphan chunk”. In an embodiment, an orphan chunk is regarded as a leaf chunk and will not be further processed to identify child chunks within it.

In an embodiment, matched chunks are also processed to determine if at least one is a leaf chunk. This is done by checking if the chunk contains terminal nodes—the definition of terminal nodes being defined earlier. If a chunk contains at least one terminal node, then the chunk is deemed a leaf chunk. If the chunk does not have any children that are chunks, the chunk is also deemed a leaf chunk.

In an embodiment, in element 804 of FIG. 8, if there are non-leaf chunks in a chunk group then the process continues to element 802 wherein the children of the non-leaf chunks are processed and repeated until all the leaf chunks are identified.

In another embodiment of the invention, the comparison of the elements in the documents may be done by cloning the content in the documents into separate and hidden iframes with the same width dimensions as the original iframes.

Taking this one step further, since 602c and its matched pair 605b are not leaf chunks, they are analyzed for child chunks. Chunks 603a and 603b are identified as child chunks of 602c and form a group chunk and 606a and 606b are identified as child chunks of 605b and form another group chunk and the chunks in one group chunk are compared to the chunks in the other group chunk are compared to each other. FIG. 10 1001 shows the results of the matching at element 803. At element 804, it is noted that although 603b and 606b contains two eligible nodes-two block elements each, in an embodiment of the invention, they are regarded as too narrow (less than 50% of the width of the content) and thus making 604a, 604b, 607a and 607b terminal nodes and thus making the parent chunks 603b and 606b “leaf chunks”.

### Highlighting Differing Chunks and Text

When all the leaf chunks are determined in an embodiment, the process proceeds to element 805 of FIG. 8. At element 805, leaf chunks that are matched to each other using the best match algorithm are displayed in the user interface 300 and they are rendered as shown in FIG. 7. As discussed above, the user interface of FIG. 7 shows visible indications, as discussed below, resulting from the method of FIG. 8.

In an embodiment, the first document 600 is rendered in the user interface as 700 and the second document 601 is rendered as 701. In an embodiment, leaf chunks are rendered as follows:

Leaf chunk pairs that are exact matches (score=1) to each other are rendered without highlights or outlines:
603a with 606a and 602d with 605c.

Leaf chunk pairs that are partial matches (score less than 1, more than 0) are highlighted in the user interface to show that a chunk has a matching chunk on the other document:
602a with 605a (highlighted as 702/708), 603b with 607b (highlighted as 704/710).

In this embodiment a dashed border or outline is drawn around the chunk. The terms outlines and borders are used interchangeably herein. Drawing outlines around elements are techniques well known to those in the art and can be achieved either by setting a CSS outline property on the chunk (i.e., outline-style: dashed), adding a border (border-style: dashed) or by placing an element matching the coordinates of the chunk above the chunk with a dashed border. Other methods familiar to those skilled in the art of placing an outline around a chunk can be used.

In an embodiment of the invention, matched chunks can be visibly labeled with matching identifiers such as numbers to visually show the user which chunks are matched with which chunk in the user interface. For example, the chunks 602a and 605a may be labeled with the number #1, and the chunks 603b and 607b may be labeled with the number #2.

iii) Leaf chunks that are orphans without a match on the other document are highlighted in a way to show that a chunk is an orphan chunk:
703.

In another embodiment of the invention, a “ghost chunk” can be inserted into the compared document 709 lacking the orphan chunk orphan chunk to show where the missing chunk would be if there was one.

In this embodiment a dotted outline is drawn around the orphan and ghost chunk.

In another embodiment of the invention, orphan chunks and ghost chunks can be labeled with matching identifiers such as numbers (i.e. “orphan 1”) to visually show the user which orphan chunks are matched with which ghost chunks in the user interface.

In element 806, the text content of matched leaf chunks that are partial matches are compared with each other and the text differences are further highlighted. In an embodiment of the invention textual elements present only in one chunk are wrapped with an <ins> tag. The method to compare textual elements between two pieces of HTML content and wrap differing content are well known to those skilled in the art.

In an embodiment of the invention CSS styles are added to add a background color to highlight the differing text by applying a background color to the <ins> tag. In the example of FIG. 6, the text difference in content within leaf chunk pairs 602a/605a are highlighted in FIG. 7 (706/707) and the text difference in content within leaf chunk pairs 603b/607b are highlighted as 705 and 711.

Other methods to compare text content and highlight them within two elements that are familiar to those skilled in the art may be used to highlight text may be used as well which include but not limited to applying an outline around the text, changing the color of the text or adding an opaque layer over the text.

### Optional Matching Optimizations

According In an alternate embodiment of the present invention an optional element is added to further provide more granular chunks, at element 803, when comparing matching leaf chunks, if a direct child of a leaf chunk has more than one direct terminal nodes, the terminal nodes are compared in the order of the DOM tree with the terminal nodes of the matched chunk. If the terminal nodes match exactly, then those terminal nodes are regarded as discarded and element 802 is applied to the matching leaf chunks to determine if there are eligible chunks within. If eligible child chunks exist then the matching leaf chunks are no longer regarded as leaf chunks and a search for the leaf chunks within the matching chunks are continued as described in the aforementioned element 802.

Furthermore, in an embodiment of the invention, in element 801 various optimizations can be performed to the DOM or copy of the DOM to make the matching process more accurate depending on the subject matter contained within the HTML documents. For example, the matching of documents can be done either by turning HTML markup into strings (such as “<div>hello</div>” using the “innerHTML” property of an element and comparing the containers or chunks to each other. An alternative comparison method uses the plain text content within the element such as by using the “innerText” property of an element (i.e. <div>hello</div>becomes hello). Using the plain text content method may be preferable when a document contains a lot of HTML markup since these markup may be similar causing a lot of noise when computing a score at element 803.

However, when using plain text comparison, fidelity is lost when elements containing images and links are compared-since by default, the URL of the image (src attribute) and URL of links (href attribute) do not get converted into plain text-hence they are compared as if links or images are not present. An embodiment of the invention takes into account links and images when comparing text, the URL of any images within an element may be appended into plain text strings prior to comparing the text at element 803 and the URL of any links within an element may be appended to plain text strings prior to comparing the text at element 803.

In an embodiment of the invention, when the documents comprise emails, appending URLs of links into plain text strings is not recommended and may not be done because many identical links (href attribute of links) are rewritten and converted into unique URLs to allow for the tracking of clicks when a recipient clicks on the link after opening. Since rewritten URLs will be different from each other, there is no point appending these URLs to the text prior to comparison. Following the same logic, when comparing markup (using innerHTML), the process in element 801 may remove the URL from links (or images if necessary) prior to comparing the strings between the two compared documents to increase the accuracy of matches.

In an embodiment of the invention, during element 802, in addition to identifying chunks by identifying “eligible nodes”, the eligible node criteria may include “special identifiers” associated with block elements. These special identifiers may include:

Identifying predetermined attributes of an element—for example “is_chunk”

le. <div is_chunk>hello how are you</div>
Therefore if any element contains these attributes (i.e., is_chunk, is_module, content_container etc . . . ), it is automatically considered a chunk.

Identifying predetermined elements, for example: <chunk>

le. <chunk>hello how are you?</chunk>
Therefore if any element comprises a predetermined set of elements (i.e., <chunk>, <module>, <content_container>), it is automatically considered a chunk.

Identifying elements within a pair of comments containing predefined attributes (i.e., chunk_start, chunk_end).

I.e., <!--(chunk_start)--><div>Hello how are you</div><!--(chunk_end)-->Therefore the top level container (div) within the comment containing the predefined attributes is automatically considered a chunk.

In an embodiment of the invention, nodes associated with “special identifiers” as mentioned in point 1,2 and 3 above are regarded as “leaf chunks”, wherein eligible nodes within these nodes are no longer evaluated as chunks.

### Comparing the Same Document Within Different Width Containers

Often HTML documents contain CSS Media Queries that modifies the styles of elements depending on the size of the window or screen containing a document. For example, a Media Query can be set to increase the font of certain elements if the window's width shrinks to a mobile phone's width to make the text easier to read in small screens—or a Media Query can be set to display in a mobile screen a button—that is hidden in wider containers—that prompts the reader to download a mobile app—since the mobile app would only be usable on a mobile device.

In an embodiment of the invention, the system would be able to display differing widths of the same document in the left 301 and right 302 document containers in the user interface 300. The left and right containers would embed the documents within an iframe which mimics a window container that can be processed by the document's media queries. In this example, the left container 301 will be set to a “desktop” width of 800 pixels wide and the right container 302 set to a “mobile” width of 400 pixels wide.

Following this example, a document containing HTML and a button comprising a block element that is initially hidden with CSS (display: none) when the document is viewed in a wide window (i.e. 800 pixels wide) but displayed when the document is viewed in a narrow window (i.e., 400 pixels wide) as seen in the example below.

```
  <div id=”button”>Mobile Button</div>
  <style>
  #button{ display:none} /*default hidden */
@media only screen and (max-width:400px) {
    #button {display: block !important}
  }
</style>
```

In an embodiment of the invention based on the example above, when displayed in a narrow container 302 the button would be considered an eligible node, but since the button is hidden in a wide container 301, it would not be considered an eligible node and therefore the algorithm in element 803 would identify the button displayed in 302 as an “orphan chunk” even though the element exists but is only hidden in 301.

Furthermore, in a further enhancement, in element 801, the process may iterate through elements in the document and identify and remove element that are visually hidden (i.e., CSS “display: none”, “visibility: hidden”). This would then allow the process to 806 to highlight that are present in both compared chunks (originally-prior to element 801) but only visible in one, since after 801 it the text will only be present in the visible chunk and the comparison algorithm in 806 would not detect the hidden/removed text in the compared. Alternatively, the removal of hidden elements may take place in other parts of the process, such as in element 806 itself.

### Highlighting Image Elements

A further embodiment of the present invention covers the ability to detect and highlight changes in image content between sections (or complete bodies) of multiple documents containing HTML. Such image content may include HTML image elements as well as elements containing images as background images.

An embodiment compares textual parts of two sets of HTML content and wraps text that is unique to one HTML content with a <ins> tag to signify that the text does not exist in the other HTML content. In a separate embodiment (not shown) text that is unique to one HTML content is appended to the other content and wrapped with a <del> tag to signify that such content does not exist in the other HTML content.

In an embodiment of the invention CSS styles are added to add a background color to highlight the differing text by applying a background color to the <ins> tag.

Other methods to compare text content and highlight them within two elements that are familiar to those skilled in the art may be used to highlight which include but not limited to applying an outline around the text, changing the color of the text or adding an opaque layer over the text. The methods to compare textual elements between two pieces of HTML content and highlight differing content are well known to those skilled in the art.

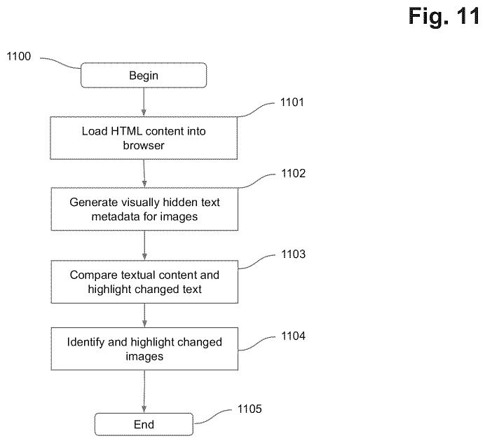

FIG. 11 is a flow chart of an embodiment of the presentation invention depicting the process of identifying and highlighting changes of image and text content between sections of two documents containing HTML.

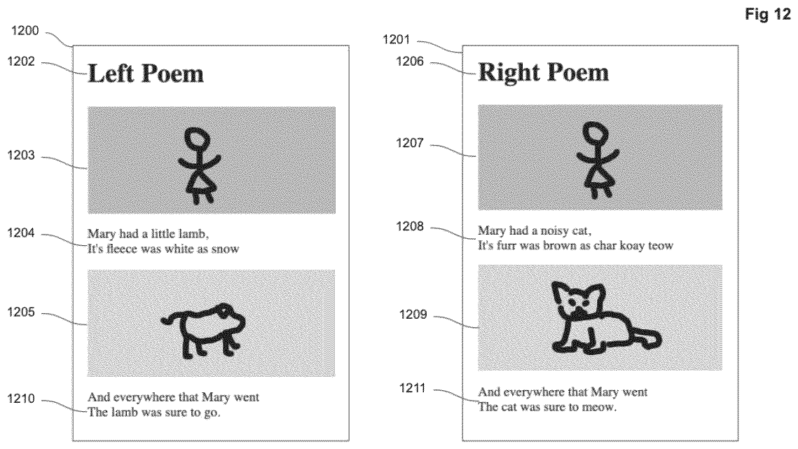

FIG. 12 is an illustration of example embodiments of sections of two documents containing HTML with differences in textual and image content.

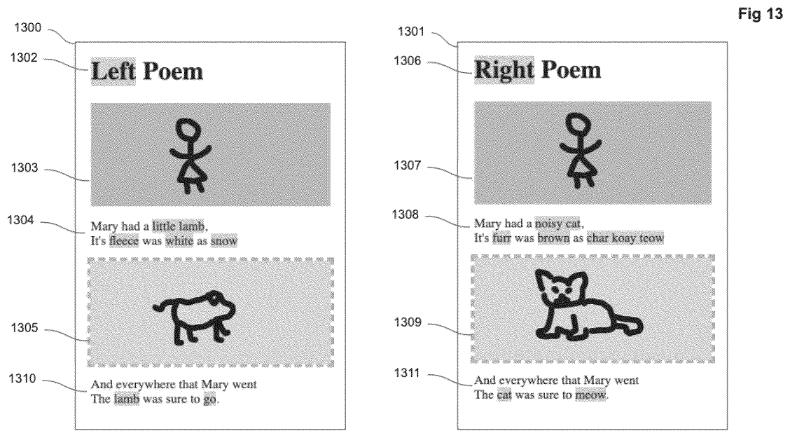

FIG. 13 is an illustration of example embodiments of sections of two documents containing HTML with differences in textual and image content (of FIG. 12) rendered in a user interface displaying highlights denoting changes in textual and image content.

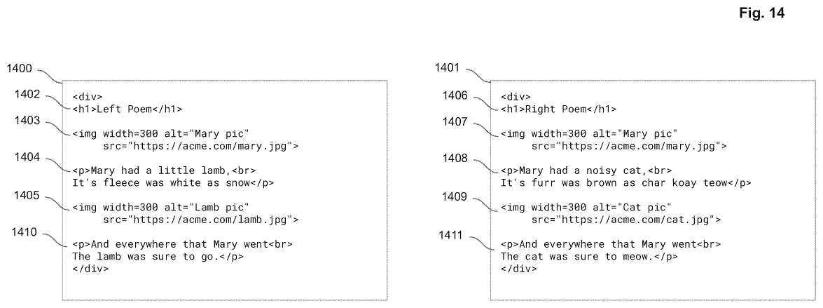

FIG. 14 is an illustration of example embodiments of the HTML markup of sections of two documents containing HTML with differences in textual and image content.

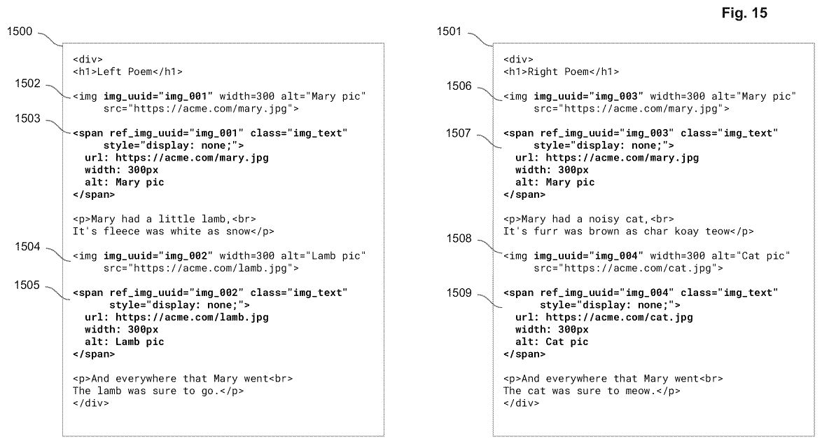

FIG. 15 is an illustration of example embodiments of the HTML markup of sections of two documents containing HTML with differences in textual and image content (of FIG. 14) after hidden text metadata for images has been generated.

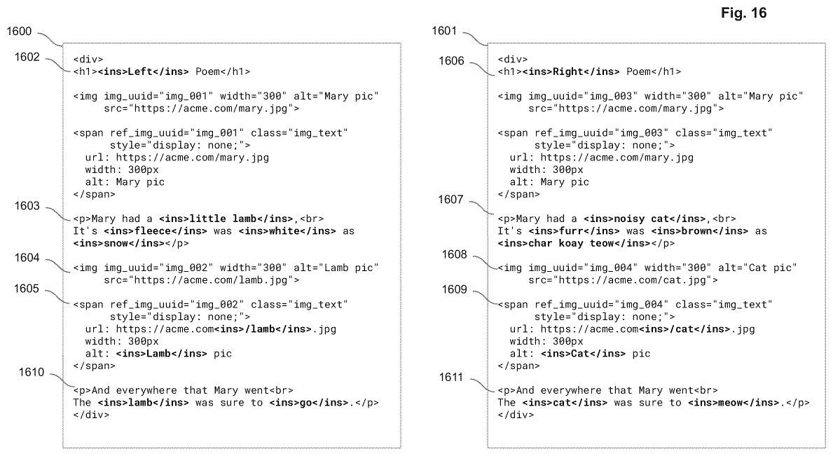

FIG. 16 is an illustration of example embodiments of the HTML markup of sections of two documents containing HTML with differences in textual and image content (of FIG. 14) after hidden text metadata for images has been generated (FIG. 15) and markup has been added to visually highlight textual changes.

At element 1100 a first section of HTML 1400 of a first HTML document as demonstrated as rendered in 1200 is selected to be compared to a second section of HTML 1401 of a second HTML document as demonstrated as rendered in 1301. It can be appreciated that the sections may be parts of a HTML document, or may represent chunks as covered in the preceding sections, or may comprise a complete HTML document. And therefore this process of 1100 may be part of element 806 or may be a completely separate flow wherein the chunking process in FIG. 8 may not be executed.

At element 1101 a first section of HTML 1400 of a first HTML document as demonstrated as rendered in 1200 is rendered into an HTML browser. The term HTML browser can encompass any application that can render HTML content including a Web browser such as Google Chrome. If the process is a continuation of element 806, then element 1101 can be skipped since the content has already been loaded into an HTML browser. In an embodiment, each section is rendered into its own iframe to segregate the CSS styles-however other methods to segregate or sandbox HTML content can be used by those familiar with the art. URL

The two sections of HTML 1400 and 1401 comprise:
Two text headers each 1402 in the first section (rendered as 1202), 1406 in the second section (rendered as 1204)
Two image HTML elements each (img) 1402, 1404 in the first section (rendered as 1202, 1204), 1406, 1408 in the second section (rendered as 1206, 1208)
Two paragraphs of text each 1404, 1410 in the first section (rendered as 1204, 1210), 1408, 1411 in the second section (rendered as 1208, 1211)
   Wherein the image elements 1203 and 1207 has the same url (https://acme.com/mary.jpg) but 1205 and 1209 although in the same area of the their respective sections has different urls (https://acme.com/lamb.jpg) and (https://acme.com/cat.jpg) The headers and paragraphs also contain differences in text.

At element 1102, textual metadata is generated for each image elements in the sections compared.

FIG. 15 1500, 1501 shows the resulting HTML markup of the original sections 1400, 1401 after the textual metadata is generated. The purpose of the textual metadata is that it converts attributes of an image element (that is not rendered as text) to text so that the difference in the image element attributes can be compared as if they were text. The wrapper of the textual metadata is hidden so it is not visible to a user when rendered. The wrapper of the textual metadata is placed at a proximate location of the image element within the HTML document. This allows the textual metadata to be compared in relation to the surrounding text so textual metadata of corresponding images located in both sections can be compared to each other.

Attributes of image elements 1502, 1504, 1506, 1508 are added as textual content 1503, 1504, 1507, 1509, within a hidden wrapper element-such as a <span> styled with the CSS “display: none”. Other methods to hide elements within HTML documents are well known to those skilled in the art may be used instead

The attributes may include but are not limited to the URL of the image element (the src attribute), the alt text attribute, the title attribute, dimension information (width and height) as well any style. In an embodiment of the invention, the hidden wrapper element and its associated image element contain a same unique identifier (i.e., img_uuid for the image and ref_img_uuid for the wrapper element) which allows for matching later.

It can be appreciated when it comes to dimensions such as with and height one or more of the following options can be used.

Image element attribute or style:

For example width=“100%” or style=“width: 100%” or width=500 or style=“width: 500 px”. This may be embedded in the wrapper element as text as:
width: 100% or width: 500 px

### Computed Image Element Dimension

This refers to the actual space the image element occupies within the rendered document. For example, an image element has a width style or attribute set to “100%” and it is placed within a container 425 px wide, the computed dimension of the image will 425 px (if there's no margin or padding).

This value can be obtained via javascript such as:
imageElement.clientWidth.

An alternate way to obtain this value is:
window.getComputedStyle (imageElement).width.

This may be embedded as:
computed_width: 425 px

Computed image dimensions may also be useful when dimension changes applied by embedded or linked (external) CSS as these dimensions are only applied when the content is rendered in a browser. (Embedded or linked CSS, as discussed in this paragraph, are not inline within the tags)

Take for example the following two HTML content (A and B) each with different embedded CSS styles containing CSS classes (myimg) that are associated with the image elements in the content.

### Content A:

<style>.myimg {width: 500 px;}</style>
<img class=“myimg” width=“300” src=“https://server/foo.jpg”>

### Content B:

<style>.myimg {width: 800 px;}</style>
<img class=“myimg” width=“300” src=“https://server/foo.jpg”>
Although there are no attribute or URL changes in the image elements, the computed width would be different because of the different respective embedded CSS styles of A and B.
le.
Content A: computed_width: 500 px
Content B: computed_width: 800 px

### Native Image Dimension

This refers to the dimension of the image element if the image element was simply placed on an empty page without containers or dimension attributes. Native image dimension is a reference to the dimension of the source image itself. A method to obtain a native image dimension is by creating an image container element and absolutely positioning it outside of the rendered document and placing a copy of the image within the container element and then reading the dimension of the image element such as in javascript:
imageElement.width or imageElement.naturalWidth.
   For example for a 500 px image, this value may be embedded as text as:
natural_width: 500 px

In an embodiment of the invention, image elements smaller than a certain dimension (such as an image element that is a single pixel wide and height) can be excluded from being compared. This is because in certain cases such as when the HTML content is part of an email, tiny images may be embedded to track if an email is opened. In this case it would not be advantageous to highlight these images. It may be advantageous to also not highlight smaller images which may be part used as “spacers” (transparent images used to pad spaces to adjust the layout of a document). In these cases, image elements under a certain dimension such as 20 pixels wide may be excluded.

At Element 1103, the text of the textual content of both sections are compared and text that is unique to one section is wrapped with a <ins> tag to signify that the text does not exist in the other section. In a separate embodiment (not shown) text that is unique to one HTML content is appended to the other content and wrapped with a <del> tag to signify that such content does not exist in the other HTML content.

In an embodiment of the invention CSS styles are added to add a background color to highlight the differing text by applying a background color to the <ins> tag.

Other methods to compare text content and highlight them within two elements that are familiar to those skilled in the art may be used to highlight which include but not limited to applying an outline around the text, changing the color of the text or adding an opaque layer over the text. The method to compare textual elements between two pieces of HTML content and highlight differing content are well known to those skilled in the art

FIG. 16 1600, 1601 shows the resulting HTML markup of the sections 1500, 1501 after the HTML content has been modified the markup to highlight the differences (additions) in the sections.

In an embodiment of the invention, textual content changes 1602, 1603, 1605, 1606, 1607, 1609, 1611 are wrapped with the <ins> element and CSS (Cascading Style Sheet) styles are added to <ins> elements to visually highlight the changes in their respective changes when rendered by a HTML capable client.

An example of a highlight CSS is the following which will set the background of changed text to the color orange:
<style> ins {background-color: orange;}</style>

In an embodiment, although the image element metadata changes are also wrapped with <ins> or <del> tags 1605, 1609, they are not visible so the image elements with changed attributes (i.e. URL) 1604, 1608 would still not be highlighted at this point. Specifically text that are unique to a section is deemed “inserted” and hence wrapped with the <ins> tag. Additionally, text that are unique to the other section but not in the current section is added to the current section and wrapped with a <del> tag. Since the textual metadata is located proximate to the surrounding textual content, textual metadata that is completely wrapped with a <del> tag would denote an image element that is unique to that section and not present in the other section.

At Element 1104, the text within the image textual metadata wrappers 1605, 1609 are processed to locate <ins> tags within it. The following Javascript code can be used to retrieve a list of <ins> elements within identify textual metadata wrappers (said wrappers contain the attribute “ref_img_uuid”):
document.querySelectorAll (“[ref_img_uuid] ins”);

The similar procedure can be used to locate <del> tags as well.

The parent nodes (the wrapper itself) 1605, 1609 of the list of located <ins> (or <del>) elements within the textual metadata wrappers can be retrieved by calling “element.parentNode”. Once the parent nodes are retrieved, the associated changed image can be located by locating the images having image_uuid attributes 1604, 1608 that matches with the ref_img_uuid value of the wrappers 1605, 1609.

The process then highlights the image elements 1604, 1608 that contain changes in the textual by applying an outline to these image elements. An example method to apply an outline in CSS is as follows:
imageElement.style.setProperty (“outline”, “5 px dashed orange”, “important”);

Other methods to apply an outline or visually highlight an image element that is changed may be used that are known to those skilled in the art such as applying borders, changing the opacity, adding a color filter over an image to change the image element's tint and applying an indicator or icon next to the image element.

At Element 1105, the process is completed. As shown in FIG. 13, at 1104, the rendered sections 1300 and 1301 have text highlights displayed 1302, 1304, 1310, 1306, 1308, 1311 as well as highlights (dashed outline) on image elements with changed attributes 1305, 1309.

### Highlighting Background Image Changes

It would be advantageous in addition to detect changes in elements between two content sections that contain different background images. Background images are not HTML image elements (<img>) but attributes applied to non HTML image elements (such as <div>, <span>, <table>, <td>) to display imagery in the background of the element.

In an embodiment of the invention at Element 1102, each element within both content sections are traversed to locate if an element contains background images. A method to obtain background image values of elements can be done using the following javascript:
window.getComputedStyle (element).backgroundImage

If the value is ‘none’, the element has no background image. Otherwise, the background image value will be returned. Using getComputedStyle is beneficial as it also allows the routine to detect background image changes in CSS set in linked (external) or embedded CSS like the following.

```
  <style> .mydiv {background-image:url(https://server/foo.jpg)
  !important;}
</style>
  <div class=”mydiv”
  style=”background-image:url(https://server/aaa.jpg)”>My
Content</div>
```

Using getComputedStyle would yield the value: https://server/foo.jpg. Whereas element.style.backgroundImage would yield the value: https://server/aaa.jpg.

In an embodiment of the invention the element of 1102 hidden textual metadata would be generated and both values would be stored in the hidden textual metadata as:
Background_image: https://server/aaa.jpg
Computed_background_image: https://server/foo.jpg

A further enhancement is to add other background attributes such as background-size and background-position as part of the textual metadata so they can be compared textually. This can be done by accessing the “background” value from the computed style instead of the “backgroundImage” value.

The hidden textual metadata is linked to the element using a similar scheme Element attribute: elem_uuid=<generated unique identifier>

Hidden textual metadata wrapper: ref_elem_uuid=<same generated unique identifier>

So, at element 1104, the similar routines would be able to detect elements within hidden textual metadata that has changed, locate the corresponding element with the changed background image and apply the highlight or outline to the element.

### Highlighting Changes in Other Non-Textual Elements

The method to highlight images can also be used to highlight changes and differences of two content sections of non-textual elements by converting attributes of those elements to hidden textual elements such as title and href attributes in links, as well as attributes of elements such as font, text color, text size, background colors and dimensions (with, height).

Using the disclosed embodiments of the present invention it would be possible to detect and highlight changes only when selected attributes of elements are changed but not others, allowing for a more precise highlighting of content.

### Other Non-HTML Documents

It can be appreciated that the invention and its embodiments can be applied to any document containing markup such as XML and not just strictly HTML.

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each element may contain one or more sub-elements. For the purpose of illustration, these elements (as well as any and all other elements identified and described above) are presented in order. It will be understood that an embodiment can contain an alternate order of the elements adapted to a particular application of a technique disclosed herein. All such variations and modifications are intended to fall within the scope of this disclosure. The depiction and description of elements in any particular order is not intended to exclude embodiments having the elements in a different order, unless required by a particular application, explicitly stated, or otherwise clear from the context.

While multiple embodiments are disclosed, still other embodiments of the present invention will become apparent to those skilled in the art from this detailed description. There may be aspects of this invention that may be practiced without the implementation of some features as they are described. It should be understood that some details have not been described in detail in order to not unnecessarily obscure the focus of the invention. The embodiments are capable of myriad modifications in various obvious aspects, all without departing from the spirit and scope of the embodiments of the present invention. Accordingly, the drawings and descriptions are to be regarded as illustrative in nature and not restrictive.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claims. It is intended that broader claims will be submitted in an application that claims the benefit of priority from this application.

### Preview Modes and Comment-Specific Display Settings

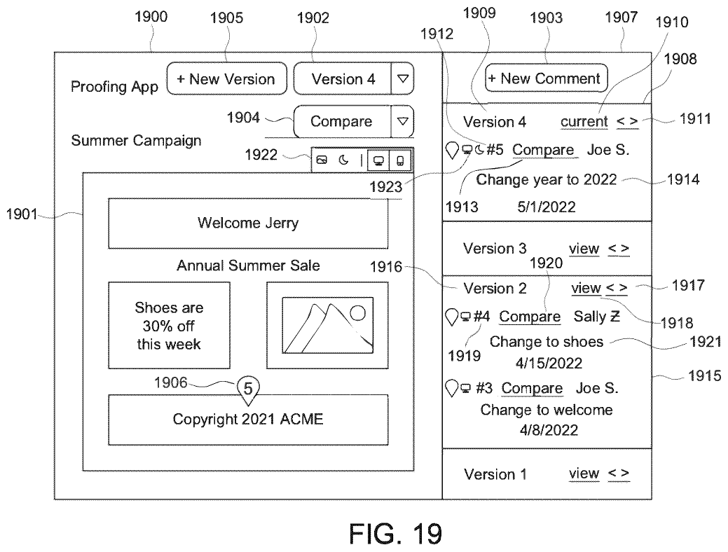

The system is embodied in a proofing interface as depicted in FIG. 19. The interface (1900) displays a version of a document in the main preview window (1901) and shows the current version number (1902). Users can add comments or annotations directly to the document via an interactive element (1903), which allows them to select specific areas of the document for annotation. The system further incorporates a dropdown menu (1904), enabling users to select different document versions for comparison. When a user selects a different version, the version of the document selected will be displayed in the main preview window (1901). New document versions can be added through another interactive element (1905), which triggers the creation of a new version. In an embodiment of the invention, a user can add a new version by uploading images, HTML files, PDF files and other media through a modal presented to a user. In addition, the modal can display an email address to a user to send an email to a specific email address. Upon receipt of this email to the specified email address, the proofing interface can designate the content within the email, such as file attachments or the HTML of the email as a new version of this document.

In an embodiment of the invention, when the document is an email, the subject, from line, preheader, HTML content and plain text content of an email are considered part of the document and displayed in the preview window (1901).

A comment is tied to a specific version of a document and can be standalone. Annotations can be a type of comment that is represented by a pin (1906) on the document, which indicates the precise location where a comment has been made. In alternative embodiments, other forms of annotations may be employed such as allowing a user to draw or add arrows on a version of a document, allowing a user to add outlines such as circles and rectangles on a section of a version of a document.

The system maintains a comprehensive comment history (1907), allowing users to see comments across all document versions.

Comments are located in a section of the proofing interface called the comment stream 1908 wherein the comments are retrieved from a database and are grouped by the version number (1909) of the document and the comments associated with the comment are sorted chronologically.

For example, comment 1908 is tied to the latest version of the document and is displayed alongside metadata, including the version number (1909) and the comment text (1914). Comments from previous versions (1915), such as version 2, are also displayed in the comment stream, with version-specific identifiers (1916) and corresponding comment text (1921).

Additional interactive elements within the proofing interface include 1910, which is an indicator that a specific comment relates to the version currently displayed in the preview window (1901). Users can compare different document versions through elements like 1911 and 1917, which, when clicked, display a dropdown menu allowing the user to select any document version for comparison. The system also provides version switching link such as 1918 to directly navigate between versions tied to specific comments, facilitating a seamless review of previous feedback. Wherein clicking the version switching link will load the version of the document in the preview window 1901 and making the version as the “current” version in the proofing interface.

### Preview Mode

Also in FIG. 19, the preview mode functionality is an essential feature that provides flexibility for users to review different versions of a document in various display formats, accommodating different viewing preferences and device types. The preview modes allow users to toggle between different views, ensuring that documents can be accurately previewed as they would appear in different contexts, such as on desktop or mobile screens.

The preview mode controls are represented by element 1922 in FIG. 19. This control allows users to switch between multiple modes for previewing the document, including but not limited to:
Desktop view: Displays the document as it would appear on a typical desktop screen, with a wider viewport.
Mobile view: Simulates how the document will look on a mobile device, shrinking the preview window to mobile dimensions (typically 400 px wide and 800 px tall).
Dark mode: Toggles the document to display in dark mode, where light background colors are inverted to darker equivalents, and text colors are inverted accordingly. This mode simulates how the document might be viewed in environments where reducing screen brightness is essential.

Images on/off mode: Allows users to toggle the display of images within the document, simulating how the document would appear if images were disabled or not displayed. This mode is useful for understanding how the document content flows without visual elements.

Additionally, the system provides metadata associated with the comments and annotations, which includes information about the preview mode in which the comment was made in this instance as icons 1923 (desktop mode and dark mode). For instance, if a reviewer added a comment while viewing the document in mobile view or dark mode, this metadata is captured and stored with the comment.

When a user clicks on a comment or annotation (e.g., 1910 or 1918) tied to a specific document version, the system adjusts the preview window to reflect the preview mode that was active when the comment was made. This ensures that the document is displayed as it was seen by the commenter, allowing for a more accurate and contextually relevant review.

In the embodiment, when a user selects a comment that was made in dark mode, image off or mobile view, the document is automatically displayed in the same mode to match the original viewing experience. This feature ensures that comments are reviewed in the proper context, particularly when the appearance or layout of the document may change depending on the selected preview mode.

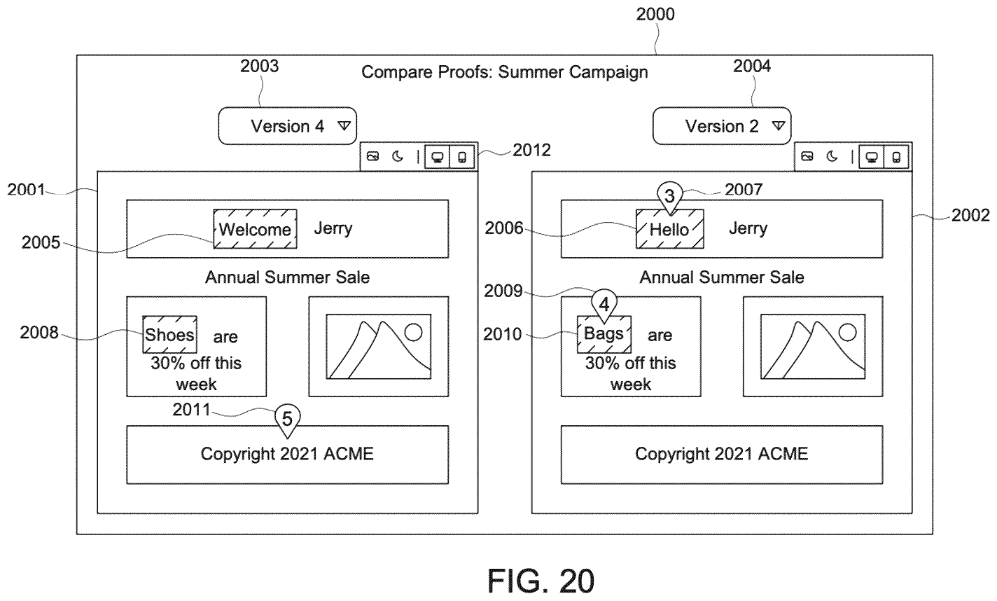

In an embodiment, the proofing interface also includes a mechanism for comparing document versions via a comparison control element. When the user selects a comparison link, such as link 1913 or 1920, the system displays a comparison user interface (shown in FIG. 20) that allows the user to view two versions of the document side-by-side.

In an embodiment, upon clicking link 1913 associated with the latest version of the document, the system will compare the latest version of the document (version 4) with the most recent previous version (version 3). Whereas when a user clicks on a comparison link 1920 of a comment that is not the latest version, the system will compare the latest version of the document (version 4) with the version of the document associated with the comparison link clicked (version 2).

### Comparison Interface

In an embodiment of the invention, the comparison user interface, depicted in FIG. 20, includes two preview panes 2001, 2002 showing versions of a document.

In an embodiment of the invention the interface shows how an interface would look like when a user clicks on a comparison link comment associated with version 2 1920. The left preview pane showing the latest version (2001) and the right displaying the earlier version (2002)—version 2. The system highlights differences between the two versions, such as changes in text or images. Each preview pane also has its own preview mode controls 2012 that allows the user to toggle between the earlier mentioned preview modes. The version numbers of the documents being compared are displayed in the interface (2003 and 2004), ensuring clarity as to which versions are being analyzed. In cases where comments or annotations are present, the system highlights these as well, displaying pins (2007, 2009, 2011) on the respective versions associated with the comments made on the respective versions of the document. The text differences are further marked, such as differences highlighted in 2005, 2006, 2008, and 2010. In this example the marking is of the type where the background of the difference in text are set in a preset color to draw the attention of the user to the differences. Other methods of marking may be used as well such as outlining the text and other forms of difference checking can be employed such as highlighting differences in the images between two versions of a document or sizes of elements.

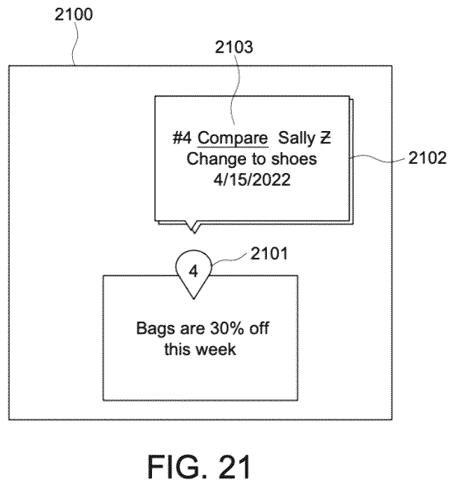

The system provides an additional layer of user interaction through a context layer, as illustrated in FIG. 21. When a user hovers over or clicks on a pin (2101), a context layer (2102) is displayed, providing a quick summary of the content of the comment without having to refer to the comment in the comment stream. This layer allows the user to interact directly with the document's annotations and comments, offering quick access to comparison features, similar to those present in the comment stream of FIG. 19.

### Comment Stream Rendering Process

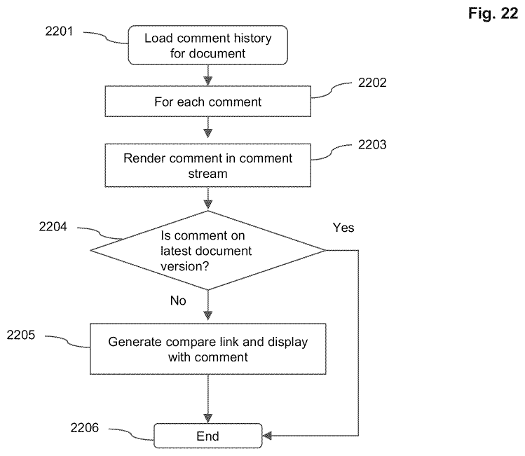

FIG. 22 depicts the process flow for loading and rendering the comment stream and its interaction with the document proofing interface. This process ensures that users can view all comments, determine their relevance to specific document versions, and interact with comparison elements as needed.

The process begins at Element 2201, where a version of the document and comment history for the document is loaded. This includes all versions of the document, and the system fetches and orders comments grouped by version for each version. After loading the comment history, Element 2202 renders each comment within a “comment stream,” which is an interface element that visually lists all comments alongside their corresponding document versions.

At Element 2203, each comment is processed individually to be displayed within the comment stream. As each comment is rendered, the system checks whether the comment was made on the latest version of the document. This occurs at Element 2204, where the system verifies if the comment relates to the current, most up-to-date version of the document (i.e., whether it I associated with the latest revision).

If the comment is determined to be made on an older version of the document, the system triggers Element 2205. Here, the system generates a comparison link or element that is displayed alongside the comment within the stream. This comparison link enables the user to compare the older version containing the comment with the latest document version. If the comment is on the latest version, in an embodiment no comparison link is needed, and the process continues directly to Element 2206, where the comment rendering process ends. In an alternate embodiment a comparison link is still added but has a different logic as mentioned above what happens when the comparison link is clicked.

### Document Comparison Process

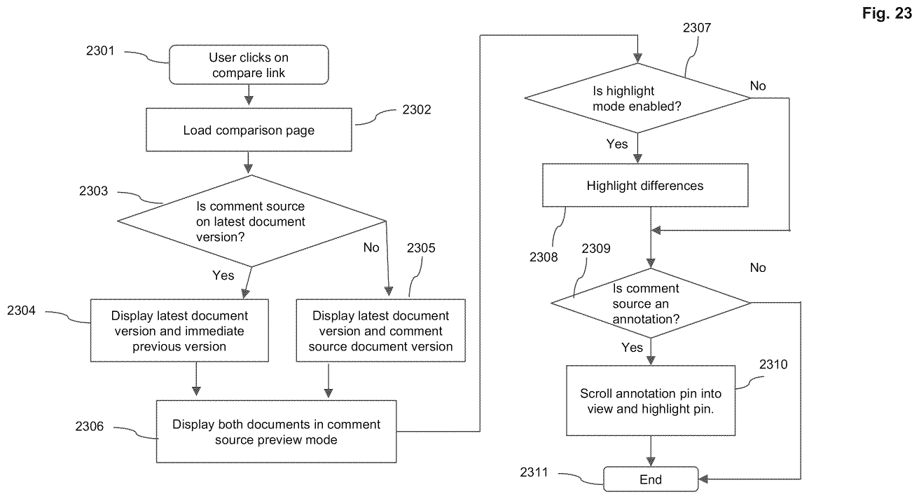

FIG. 23 details the process flow for what occurs when a user clicks on a “compare” link (such as 1913 or 1920 in FIG. 19) to trigger a comparison between two document versions. This flow ensures that users can efficiently compare the version associated with the compare link with a different version of the document.

The process begins at Element 2301, where a user clicks on a comparison link within the proofing interface. Upon this action, Element 2302 loads the comparison page, which displays two panes for side-by-side document comparison (as illustrated in FIG. 20).

In Element 2303, the system checks whether the source of the comment that triggered the comparison is associated with the latest version of the document. If the comment is tied to the latest document version, Element 2304 displays the current version in one pane (e.g., 2001) and the immediately preceding version in the other pane (e.g., 2002).

If the comment source is associated with an older version of the document, the system proceeds to Element 2305, where it displays the latest document version in one pane and the version of the document tied to the source comment in the other pane. This enables the user to directly compare the changes between the comment's version and the latest revision.

In Element 2306, the system checks whether any metadata, such as a preview mode, is associated with the comment (e.g., mobile view, dark mode, or hidden image mode). If such metadata is present, the system applies the corresponding display mode to both panes. For example, if the comment was made in a dark mode view, both document versions are displayed in dark mode. If the comment was made in mobile view, both panes are rendered in a mobile screen size, typically 400 px wide and 800 px tall, similarly if the commend was made in desktop view, both panes are rendered in a desktop screen size, typically at least 600 px side, and if the comment was made in image hidden mode, both panes are rendered with images hidden.

Next, Element 2307 checks whether highlight mode is enabled for the comparison interface. In Element 2308, if highlight mode is enabled (as is the default), the system highlights text and image differences between the two document versions. The highlighting process emphasizes areas of the document where changes have occurred, making it easier for the user to identify modifications.

If the comment is an annotation 2309 (i.e., a specific point or location on the document itself), Element 2310 is initiated. Here, the system checks if the annotation pin (also called a pin) associated with the comment is visible within the current window view of the preview pane. If the pin is not visible (for instance, if the document is too tall to display all at once within the window), the system automatically scrolls the window to bring the pin into view. Additionally, to draw attention to the annotation, the system highlights the pin through visual means such as blinking or flashing. In an embodiment, when the document is scrolled in one pane to reveal the pin, the other pane is simultaneously scrolled to the corresponding section of the document. This synchronized scrolling ensures that the user can compare both versions of the document at the same location. If the document are of a different height, the scrolling on both windows can either be the amount of pixels scrolled on the window to display the pin, or by using a percentage—for example if the windows with the pin is scrolled 70%, the other window is also scrolled by 70% regardless of the actual height. When scrolling using pixels, this can result in the other pane running out of space to scroll if it is shorter, in an embodiment of this invention, the other pane simply stops scrolling when it reaches the bottom.

To ensure user attention, the system further highlights the pin by blinking or displaying the annotation's associated text in a context layer near the pin as seen in 2102 on FIG. 21.

Finally, Element 2311 concludes the process.

### Other Uses for the Proofing Interface: Comparing Variations of a Document

Although the aforementioned spec primarily is concerned between comparing multiple versions of a document. It can be appreciated that the same features can be used to compare multiple variations of documents containing similar content. This can be useful when two separate documents are created from the same template and the invention can be used to compare multiple variations of document. Therefore, the terms “versions” and “variations” may be used interchangeably.

### Annotating Highlighted Content While Preserving Annotation Accuracy Across Rendering States

An embodiment of the invention pertains to annotating content, including highlighted areas within rendered documents, and ensuring annotations remain accurate and functional irrespective of whether temporary highlight elements are present or removed. Users frequently annotate documents by placing pins or comments directly on the rendered content, including highlighted areas. However, temporary highlight elements alter the document structure, creating challenges when annotations rely on coordinates within these elements. When highlights are toggled off or removed, annotations may lose their intended placement and relevance since the highlight element that serves as the point of reference for the annotation no longer exist.

This embodiment provides a method for annotating content in a proofing interface, particularly in workflows involving temporary highlights. Highlights are applied dynamically using markup elements, such as <ins>, to emphasize changes between document versions. Users place annotation pins on these highlighted or non-highlighted areas. The system ensures that pins remain accurately positioned by recording their placement relative to a stable parent element, referred to as the “target element,” even when highlight elements are toggled off.

In this embodiment of the invention, the highlight element is an <ins> element. The ins element is styled with adding the following background color CSS to the HTML to make the highlight background appear yellow:

```
  ins {
  background-color: yellow;
}
```

Any other element can be used as a highlight element as long as there is a way to style the element to highlight content within. Other methods may include adding special class names that are tied to special CSS background styles. However, the <ins> element is used because it is unlikely to be present in most documents.

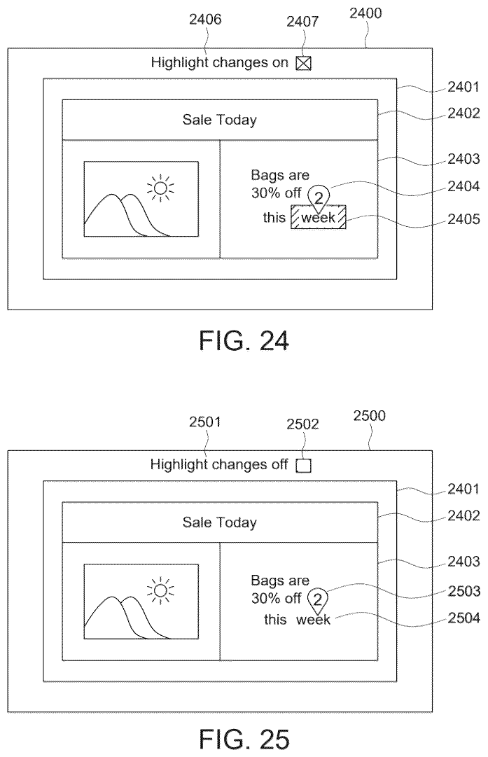

FIG. 24 illustrates an embodiment of the proofing interface (2400), which includes a document display pane (2401) for rendering content. The interface also contains a table (2402) within the document being proofed, which is an example of the document structure. The table cell (2403) in the second row contains text that is highlighted by a highlight element (2405). Annotation pins (2404) can be placed by users on highlighted or non-highlighted content. In some embodiments, the state of the highlight mode is reflected by an indicator (2406), and highlight mode is controlled using a toggle (2407).

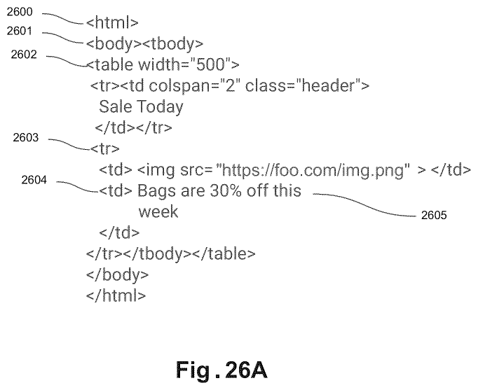

When highlight mode is disabled, as shown in FIG. 25, the highlight elements (2405) are removed, leaving the original content (2504) intact. The annotation pin (2503) persists accurately because its placement is recorded relative to a target element, unaffected by highlights.

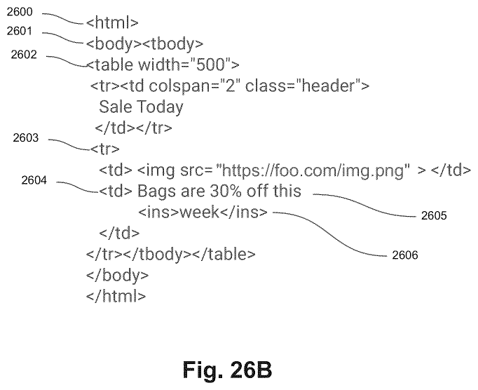

FIG. 26A shows the HTML structure of a document before highlights are applied. The document includes a table (2602) with rows (2603) and cells (2604) containing text (2605). FIG. 26B shows the same content with highlights applied, where the text is wrapped in a highlight element (2606), such as <ins>.

To ensure the accuracy of annotations, the system records coordinates calculated relative to the target element unaffected by highlights. In addition, the system generates XPath references that exclude highlight elements.

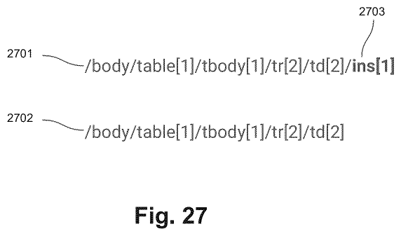

XPath is a string representation of an element's location within the hierarchical structure of an HTML or XML document. It provides a precise navigation path to specific elements using a hierarchical syntax of parent, child, and sibling relationships. FIG. 27 demonstrates two XPath approaches. The first, shown as 2701, generates a reference that includes highlight elements, such as <ins>2703. This approach creates a dependency on the temporary highlight elements and results in an invalid XPath if the highlights are removed. The second approach, shown as 2702, excludes highlight elements by traversing to the nearest stable parent. This independent XPath ensures that annotations remain functional even when highlight elements are toggled off or removed, thereby addressing the limitations of the first approach.

### Annotation Placement Process

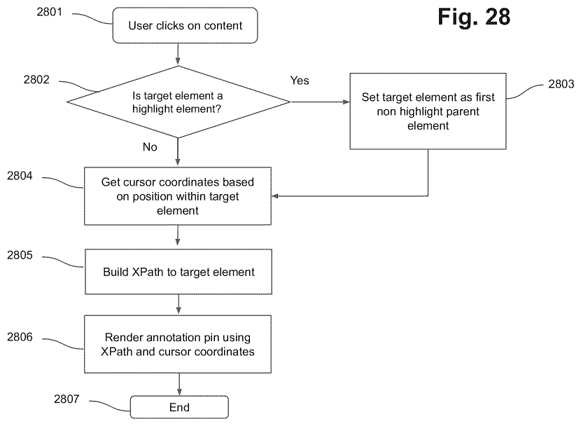

The process for placing and recording annotation pins is depicted in FIG. 28. At step 2801, a user clicks or taps on an element in the document to initiate annotation placement. This element is initially designated as the target element.

At step 2802, the system checks if the target element is a highlight element, such as an <ins> tag. If the target element is a highlight element, the system traverses the DOM hierarchy to locate the nearest non-highlight parent element. For example, the traversal may use the following script:

if (element.tagName === ‘INS’)
{
element = element.parentNode;
}

At step 2803, the non-highlighted parent element is assigned as the target element. This allows a pin to be persistent, even if the highlight is removed at a later time. At step 2804, coordinates (i.e., X and Y coordinates) of the pin are calculated relative to the boundaries of the target element. Once the coordinates are calculated, the system builds an XPath to the target element at step 2805.

Examples of XPath references are shown in FIG. 27. For instance, in FIG. 24, where the annotation pin 2404 is placed on content wrapped by the highlight element 2405, two XPath strings are possible. XPath 2701 includes the highlight element 2703 in the reference, while XPath 2702 excludes the highlight element by referencing only the parent. The process in FIG. 28 ensures that the XPath will not include highlight elements, resulting in the generation of XPath 2702.

The exclusion of the highlight element from the XPath is critical for annotation persistence. If the document is rendered without highlight elements, an XPath that includes the highlight (e.g., 2701) would become invalid, as the <ins> tag would no longer exist in the DOM. By generating an XPath like 2702, which references only the stable parent element, the system ensures that annotations remain accurately positioned regardless of the presence or absence of highlights.

At step 2806, both the coordinates and the XPath are used to render the annotation pin at the desired location. The process concludes at step 2807. As mentioned above, this method can also be used for annotations such as comments, etc. where it is desirable that the annotation have a persistent location, whether or not highlights are being displayed.

### Alternate Embodiment: Pointer-Event Disabling

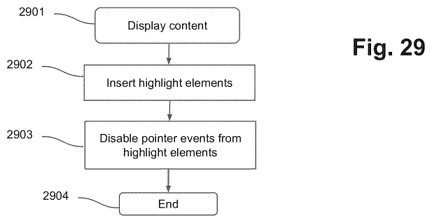

FIG. 29 depicts an alternate embodiment that simplifies the process of annotation placement by disabling pointer events for highlight elements. Pointer events, as defined by the CSS pointer-events property, determine whether an element can capture click, tap, or other pointer interactions from the user. By disabling pointer events on highlight elements, the system ensures that user clicks pass through the highlight elements and are captured by the underlying non-highlight elements. Other methods to disable pointer events on highlight elements may be used that are familiar to persons skilled in the art.

The process begins at step 2901, where the document is displayed in its original state, without any highlight elements applied. This state serves as a baseline for rendering content in the proofing interface.

At step 2902, highlight elements are dynamically added to the document to emphasize changes or differences between versions. For example, as shown in FIG. 24, the <ins> tag (2405) is added around text within a table cell (2403) to visually indicate alterations. These highlight elements typically include CSS properties, such as background color, to make the changes prominent to the user.

At step 2903, the system disables pointer events for the highlight elements by applying the CSS property pointer-events: none. For example, the following CSS rule may be applied:

ins {
pointer-events: none;
}

This rule ensures that the <ins> elements, which function as highlight elements, no longer capture pointer interactions such as mouse clicks, taps, or hover events. When pointer events are disabled on highlight elements, any user interaction (e.g., clicking or tapping) is passed through the highlight element to the element underneath. For instance, if a user clicks on text wrapped in an <ins> element, the click event is automatically handled by the parent table cell (2403), as shown in FIG. 24, rather than the <ins> element itself. This effectively bypasses the need for the system to detect and traverse the DOM to locate the stable, non-highlight parent element (as performed in FIG. 28 2803).

At step 2904, the content, including the disabled pointer-event highlight elements, is fully displayed to the user. The user may then interact with the document by clicking on elements to place annotation pins. These interactions are seamlessly passed through the highlight elements, and the pins are accurately placed relative to the underlying stable parent elements.

This alternate embodiment complements the process described in FIG. 28, offering a simpler and more efficient method for managing annotations when highlights are applied dynamically. While FIG. 28 relies on DOM traversal to locate non-highlight elements, FIG. 29's pointer-event disabling avoids the need for such traversal.

### Highlighting Process in Document Comparison and Annotation

The processes and systems described in the preceding sections can be applied to both single-window and dual-pane document comparison workflows, as illustrated by the relationship between FIGS. 24, 25, 29, and 20. Specifically, the proofing interface in FIGS. 24 and 25 can represent the two comparison windows (2001 and 2002) shown in FIG. 20, where two versions of a document are rendered side by side to allow the user to identify and annotate differences.

FIG. 29 focuses on the process of rendering content in a single window, whether it is part of a single-window or dual-pane comparison workflow. In this scenario, the system renders the original content that does not contain highlight elements, and highlight elements are dynamically added to visually indicate differences between document versions.

In this process, the application begins by rendering the original content without highlight elements. Highlight elements are then dynamically added to visually indicate differences between document versions.

Two alternate embodiments handle user interactions with highlight elements. In one embodiment, pointer events on highlight elements are disabled at step 2903, ensuring that user clicks pass through the highlight element to the underlying non-highlight parent element. In the other embodiment, if pointer events are not disabled, the system executes the DOM traversal method at step 2803, which locates the first non-highlight parent element of the highlight element.

Once the user clicks on a point within a highlight element, the system calculates the click's coordinates relative to the boundaries of the non-highlighted parent element. Additionally, an XPath string is generated, terminating at the non-highlighted parent element and excluding the highlight element itself.

The calculated coordinates and the generated XPath string are stored as pin location metadata. This metadata is then used to render a pin at the clicked location, accurately positioning it even within a highlight element.

The stored metadata ensures that when the document is rendered a second time, the pin is correctly placed, even if highlight mode is toggled off and the highlight elements are no longer present. The accuracy is maintained because the XPath references the stable, non-highlight parent element.

1. A method for comparing versions of HTML documents in a proofing interface, comprising:
displaying a preview window displaying a version of a document containing a plurality of versions of a document, the plurality of versions containing at least an early version and a later version, wherein the later version is a revision of the early version;
displaying a list of comments on the proofing interface, the list of comments containing at least a first comment associated with the early version and a second comment associated with the later version; and
displaying a comparison control element on the first comment wherein a user action of the comparison control element will display a comparison page, the comparison page containing a first comparison window displaying the early version of the document and a second comparison window displaying the later version of the document.

2. The method of claim 1,
wherein the preview window contains a plurality of preview mode controls displaying characteristics within the preview window and associating a first preview mode metadata with the first comment wherein the first preview mode metadata reflects preview mode selections by a user when the first comment was recorded; and
setting the preview mode of the first comparison window and of the second comparison window to the first preview mode to reflect the display characteristics associated with the first preview mode.

3. The method of claim 2,
wherein the display preview mode has dark mode on, wherein the display characteristic involves at least a partial inversion of some colors of a document, and at least partially inverting the colors of the document in both the first comparison window and the second comparison window.

4. The method of claim 2,
wherein, when a display preview mode mobile view is on, the display characteristic involves shrinking the preview window displaying a document to a preset mobile dimension from a default dimension; and at least shrinking both first and second comparison window to the mobile dimension.

5. The method of claim 2,
wherein, when a display preview mode mobile view is on, the display characteristic involves shrinking the preview window displaying a document to a preset mobile dimension from a default dimension; and at least shrinking both first and second comparison window to the mobile dimension.

6. The method of claim 1,
wherein the first comment is an annotation wherein a point has been recorded on a specific location on a rendered document in the preview window, the first comment also containing comment text; and
loading the first comparison window with the first version having the document on first version being taller than the first comparison window and the specific location of the annotation located at a location outside the comparison window;
automatically scrolling the window where the annotation location is visible; and
displaying a visual marker on the location, the second comparison window also scrolling by same proximate distance as first comparison window.

7. The method of claim 6, where the visual marker is highlighted by an animation.

8. The method of claim 6, where a text area is shown next to a pin containing the comment text.

9. A method for annotating a document in a proofing interface that allows temporary highlights, comprising:
receiving an indication from a user that an element of the document is a highlight element;
determining a target element, the target element comprising a nearest non-highlight parent element of the highlight element;
determining coordinates of an annotation, relative to boundaries of the target element;
building an XPath to the target element, where the XPath is a representation of a location of an element within a hierarchical structure of the document; and
using the determined coordinates and the XPath to render the annotation at a desired location in the proofing interface, thus allowing the annotation to be persistently located on the document whether or not the document is displayed with highlights.

10. The method of claim 9, wherein the interface includes a toggle that allows a user to indicate whether the document should be viewed with or without highlights, while still persistently displaying the annotation.

11. A method to compare a first and a second hypertext markup language (HTML) documents, comprising:
identifying a plurality of hierarchical chunks in the two HTML documents a hierarchy of chunks having at least a leaf chunk and a non-leaf chunk where the leaf chunk is within the non-leaf chunk;
rendering the two HTML documents and displaying the rendered documents on a user interface, the rendered documents including rendering of the identified plurality of chunks;
repeating the following until a current chunk in one of the two HTML documents is a non-leaf chunk;
comparing a current chunk in the first HTML document to a current chunk in the second HTML document to determine a string similarity score for the current chunks to determine if the compared chunks are matched leaf chunks;
visually highlighting, on the user interface, matched leaf chunks containing differing content; and
visually highlighting, on the user interface, differing text within matched leaf chunks.

12. The method of claim 11, further comprising:
preprocessing child elements of a hierarchical HTML elements of the two HTML documents, wherein at least one child element is modified to enhance the comparing.

13. The method of claim 12, wherein the preprocessing comprises:
preprocessing different width containers in the two HTML documents.

14. The method of claim 12, wherein the preprocessing comprises:
preprocessing image elements in the two HTML documents.

15. The method of claim 12, wherein the preprocessing comprises:
preprocessing the two HTML documents to obtain computed element dimensions for the rendered documents.

16. The method of claim 12, wherein the preprocessing comprises:
preprocessing the two HTML documents to determine native image dimensions.

17. The method of claim 12, wherein the preprocessing comprises:
preprocessing the two HTML documents to modify background images.

18. A system having a user interface, comprising:
a data processing system displaying the user interface, the user interface comprising:
a first area to display a first rendered HTML document;
a second area to display a second rendered HTML document;
a first user input area to receive user input indicating that high-level portions of the rendered HTML documents that differ should be highlighted; and
a second user input area to receive user input indicating that text of the rendered HTML documents that differ should be highlighted.

19. The system of claim 18, in which the user interface further comprises:
a third user input area to receive user input indicating that a mobile view of the rendered HTML documents should be displayed.

20. The system of claim 18, wherein the rendered HTML documents in the user interface are displayed to highlight differences within matching containing blocks in at least one of:
a. text content in the rendered HTML documents, or
b. image content in the rendered HTML documents,
wherein containing blocks comprise a rectangular element that contains HTML content.
